(19) United States
(12) Patent Application Publication
(10) Pub. No.: US 2026/0342864 A1
(43) Pub. Date: Oct. 29, 2026

(54) LIVE STREAMING INTERACTION METHOD, SERVER, USER DEVICE, AND ELECTRONIC DEVICE

(71) Applicant: BEIJING ZITIAO NETWORK TECHNOLOGY CO., LTD., Beijing (CN)

(72) Inventors: Fuxing CHEN, Beijing (CN); Bojun CHEN, Beijing (CN)

(21) Appl. No.: 19/658,356

(22) Filed: Apr. 24, 2026

(30) Foreign Application Priority Data
Apr. 25, 2025 (CN) 202510534831.5

(51) Int. Cl. H04L 65/401; H04L 51/046; H04L 65/1089; H04L 65/403

(52) U.S. Cl. CPC H04L 65/4015; H04L 51/046; H04L 65/1089; H04L 65/403

(57) ABSTRACT

The present disclosure relates to the field of information technology, and in particular, to a live streaming interaction method, a server, a user device, and an electronic device. The live streaming interaction method includes: sending an invitation to a second user, in response to receiving a request for communicating with the second user sent by a first user, wherein at least one of the first user or the second user is a user in a first real-time communication channel of a live streaming; creating, for the live streaming, a second real-time communication channel for communication between the first and second user, wherein the second real-time communication channel is different from the first real-time communication channel; and sending a configuration corresponding to the second real-time communication channel to the first and second user, so that the first and second user enter the second real-time communication channel according to the configuration.

### CROSS-REFERENCE TO RELATED APPLICATIONS

This application claims priority to Chinese Patent Application No. 202510534831.5, entitled “live streaming interaction method, server, user device, and electronic device”, and filed on Apr. 25, 2025. The entire disclosure of the prior application is hereby incorporated by reference in its entirety.

### TECHNICAL FIELD

The present disclosure relates to the field of information technology, and in particular, to a live streaming interaction method, a server, a user device, an electronic device, a computer-readable storage medium, and a computer program product.

### BACKGROUND

In current Internet social scenarios, traditional one-to-one or one-to-many live streaming forms can no longer fully meet diverse social needs of users. A live multi-user chat room comes into being, which integrates instant messaging and live streaming interaction functions, and allows a large number of users to communicate online at the same time. In the live multi-user chat room, a streamer can co-host with a guest, and push content of the co-hosting with the guest to clients of other audiences, providing a new mode for live streaming.

However, the live multi-user chat room in the related art only supports a co-hosting conversation between the streamer and the guest, and does not support conversations between other users, resulting in a monotonous interactive content provided for the guest and affecting user experience.

### SUMMARY

In view of this, embodiments of the present disclosure provide a live streaming interaction method, a server, a user device, an electronic device, a computer-readable storage medium, and a computer program product, by creating a new real-time communication channel under the same live streaming, allowing a guest in co-hosting and other users to establish real-time communication, to further meet social needs of users, thereby improving user experience.

According to some embodiments of the present disclosure, a live streaming interaction method is provided, applied to a server, including: sending an invitation to a second user, in response to receiving a request for communicating with the second user sent by a first user, wherein at least one of the first user or the second user is a user in a first real-time communication channel of a live streaming; creating, in the live streaming, a second real-time communication channel for communication between the first user and the second user, wherein the second real-time communication channel is different from the first real-time communication channel; and sending a configuration corresponding to the second real-time communication channel to the first user and the second user, so that the first user and the second user enter the second real-time communication channel according to the configuration.

According to some other embodiments of the present disclosure, a live streaming interaction method is provided, applied to a user device, including: sending, by a first user, an invitation to communicate with a second user, wherein at least one of the first user or the second user is a user in a first real-time communication channel of a live streaming; and receiving a configuration corresponding to a second real-time communication channel of the live streaming, to enter the second real-time communication channel according to the configuration, wherein the second real-time communication channel is different from the first real-time communication channel, and is configured for communication between the first user and the second user.

According to some further embodiments of the present disclosure, a server is provided, including: a first sending module configured to send an invitation to a second user, in response to receiving a request for communicating with the second user sent by a first user, wherein at least one of the first user or the second user is a user in a first real-time communication channel of a live streaming; a creation module configured to create, in the live streaming, a second real-time communication channel for communication between the first user and the second user, wherein the second real-time communication channel is different from the first real-time communication channel; and a second sending module configured to send a configuration corresponding to the second real-time communication channel to the first user and the second user, so that the first user and the second user enter the second real-time communication channel according to the configuration.

According to some yet further embodiments of the present disclosure, a user device is provided, including: a sending module configured to send, by a first user, an invitation to communicate with a second user, wherein at least one of the first user or the second user is a user in a first real-time communication channel of a live streaming; and a receiving module configured to receive a configuration corresponding to a second real-time communication channel of the live streaming, to enter the second real-time communication channel according to the configuration, wherein the second real-time communication channel is different from the first real-time communication channel, and is configured for communication between the first user and the second user.

According to some embodiments of the present disclosure, an electronic device is provided, including: at least one memory; and at least one processor coupled to the at least one memory, the at least one processor configured to, based on instructions stored in the at least one memory, carry out the method of any of the embodiments described in the present disclosure.

According to some embodiments of the present disclosure, a computer-readable storage medium is provided, having a computer program stored thereon, which, when executed by a processor, executes the method of any of the embodiments described in the present disclosure.

Other features, aspects, and advantages of the present disclosure will become apparent through the following detailed description of exemplary embodiments of the present disclosure with reference to the drawings.

### BRIEF DESCRIPTION OF THE DRAWINGS

Embodiments of the present disclosure are explained hereinafter with reference to the drawings. It is to be understood these descriptions are only illustrative and are not intended to limit the scope of the present disclosure. In the drawings:

FIG. 1 shows a flowchart of a live streaming interaction method according to some embodiments of the present disclosure;

FIG. 2 shows a schematic diagram of a system architecture according to some embodiments of the present disclosure;

FIG. 3 shows a schematic diagram of a display interface according to some embodiments of the present disclosure;

FIG. 4 shows a schematic diagram of a connection channel according to some embodiments of the present disclosure;

FIG. 5 shows a flowchart of a live streaming interaction method according to some other embodiments of the present disclosure;

FIG. 6 shows a schematic diagram of a user side system architecture according to some embodiments of the present disclosure;

FIG. 7 shows a flowchart of a live streaming interaction method according to some yet other embodiments of the present disclosure;

FIG. 8 shows a schematic diagram of a stream pulling process according to some embodiments of the present disclosure;

FIG. 9 shows a schematic diagram of a display interface according to some other embodiments of the present disclosure;

FIG. 10 shows a schematic diagram of a display interface according to some yet other embodiments of the present disclosure;

FIG. 11 shows a signaling flowchart of a live streaming interaction method according to some embodiments of the present disclosure;

FIG. 12 shows a signaling flowchart of a live streaming interaction method according to some other embodiments of the present disclosure;

FIG. 13 shows a block diagram of a server according to some embodiments of the present disclosure;

FIG. 14 is a block diagram of a user device according to some embodiments of the present disclosure;

FIG. 15 shows a block diagram of an electronic device according to some embodiments of the present disclosure; and

FIG. 16 shows a block diagram of an electronic device according to some other embodiments of the present disclosure.

It is to be understood that, for ease of description, the dimensions of the various components shown in the drawings are not necessarily drawn to scale. The same or similar reference numerals are used in the drawings to refer to the same or similar components. Therefore, once an item is defined in one drawing, it may not be discussed further in subsequent drawings.

### DETAILED DESCRIPTION

The technical solutions in the embodiments of the present disclosure are clearly and completely described hereinafter with reference to the drawings in the embodiments of the present disclosure. It is to be understood that the present disclosure may be implemented in various forms and should not be construed as limited to the embodiments set forth herein.

It is to be understood that the various steps recited in the method implementations of the present disclosure may be performed in a different order, and/or performed in parallel. In addition, the method implementations may include additional steps and/or omit performing the illustrated steps. The scope of the present disclosure is not limited in this respect. Unless otherwise specifically stated, the relative arrangements of components and steps, numerical expressions, and numerical values set forth in these embodiments are to be construed as merely exemplary and do not limit the scope of the present disclosure.

The term "include/comprise" and variations thereof used in the present disclosure are open-ended terms that mean "include/comprise at least" but do not exclude other elements/features, that is, "include/comprise but not limited to". The term "based on" means "based at least in part on".

It is to be noted that concepts such as "first" and "second" mentioned in the present disclosure are only used to distinguish between different apparatuses, modules, or units, and are not used to limit an order or interdependence of functions performed by these apparatuses, modules, or units. Unless otherwise specified, concepts such as "first" and "second" are not intended to imply that objects so described must be in a given order temporally, spatially, in terms of ranking, or in any other way.

It is to be noted that the modifiers "one" and "a plurality of" mentioned in the present disclosure are illustrative and not restrictive, and those skilled in the art should understand that they should be construed as "one or more" unless clearly expressed in the context.

The names of messages or information exchanged between a plurality of apparatuses in the implementations of the present disclosure are only for illustrative purposes, and are not intended to limit the scope of these messages or information.

The user information (including but not limited to user device information, user personal information, etc.) and data (including but not limited to data for analysis, stored data, displayed data, etc.) involved in the present disclosure are all information and data authorized by the users or fully authorized by all parties, and the collection, use, and processing of the relevant data need to comply with the relevant laws, regulations, and standards of the relevant countries and regions, and provide corresponding operation entrance for the users to choose to authorize or reject.

The embodiments of the present disclosure are described in detail below with reference to the drawings, but the present disclosure is not limited to these specific embodiments. The following specific embodiments may be combined with each other, and the same or similar concepts or processes may not be repeated in some embodiments. In addition, in one or more embodiments, a particular feature, structure, or characteristic may be combined in any suitable manner that will be clear to those of ordinary skill in the art from this disclosure.

The live multi-user chat room in the related art provides a monotonous interactive content for the guest, which affects user experience. In order to improve user experience, embodiments of the present disclosure provide a live streaming interaction method, by creating a new real-time communication channel for the same live streaming, allowing a guest in co-hosting and other users to establish real-time communication, and providing more diverse interaction manners for users in the live streaming, thereby improving user experience.

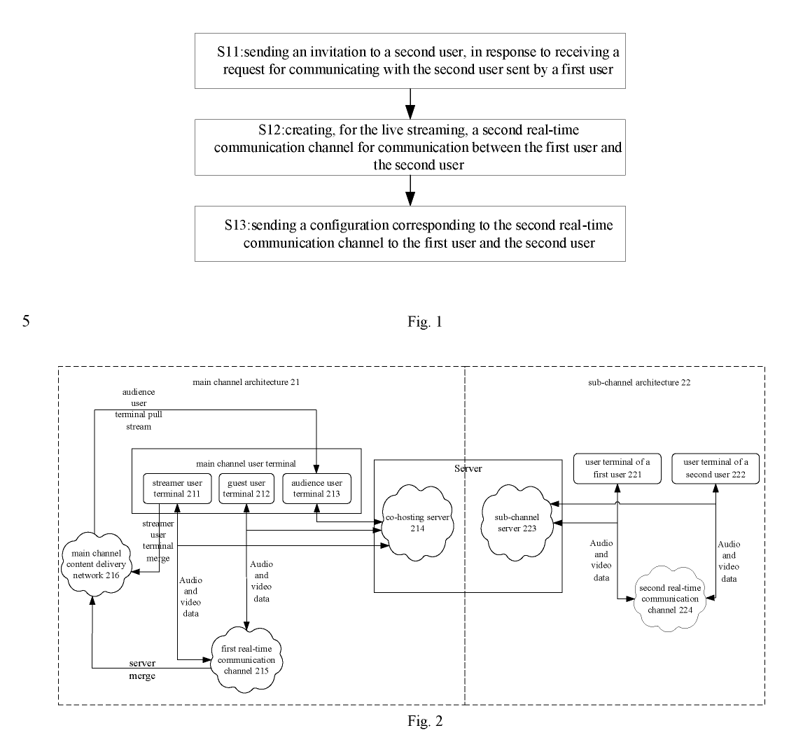

FIG. 1 shows a flowchart of a live streaming interaction method according to some embodiments of the present disclosure.

As shown in FIG. 1, the live streaming interaction method applied to a server includes: Step S11, sending an invitation to a second user, in response to receiving a request for communicating with the second user sent by a first user, wherein at least one of the first user or the second user is a co-hosting user in a first real-time communication channel of a live streaming; Step S12, creating, for the live streaming, a second real-time communication channel for communication between the first user and the second user, wherein the second real-time communication channel is different from the first real-time communication channel; and Step S13, sending a configuration corresponding to the second real-time communication channel to the first user and the second user, so that the first user and the second user enter the second real-time communication channel according to the configuration.

Generally, live streaming refers to an activity of continuously and instantaneously publishing real-time information in a form of, but not limited to, video, audio, and picture and text to the public through an information acquisition device based on Internet communication technologies and by means of a network platform with a data transmission function and related applications, in a virtual space constructed during this process for real-time information interaction between a streamer and an audience. In the present disclosure, when describing an online virtual space for information display and interactive communication functions, "live streaming" and "live streaming room" have similar meanings in terms of functions and properties, and both of them are capable of supporting the streamer to release real-time information and supporting the audience to participate in interactions through comments, bullet screens, rewards, etc. In the following description of the embodiments, no specific distinction will be made between the two unless otherwise specified.

Co-hosting is a real-time audio and video interaction technology that enables synchronous communication of multiple users through a low-latency transmission protocol. The streamer may have a direct online conversation with the audience, a guest, or other streamers, including two-user co-hosting and multi-user co-hosting. Users in co-hosting break the space limit through a camera and a microphone to achieve face-to-face communication. During co-hosting, users may share their views, show their talents, answer questions, etc., which greatly enhances the interest and participation of the live streaming, and allows the audience to deeply integrate into the atmosphere of the live streaming, and has become a popular way of live streaming interaction at present.

In step S11, the first user forwards an invitation to communicate with the second user through the server. The first user is an inviter of the communication. The second user is an invitee of the communication.

The first user and the second user described above may be co-hosting users or audiences. The co-hosting users may include a streamer user and a non-streamer user. The streamer user refers to a streamer who opens a live streaming room, and the non- streamer user refers to a guest who co-hosts with the streamer in the live streaming room.

That at least one of the first user or the second user is a co-hosting user in the first real-time communication channel of the live streaming room means that, the live streaming interaction method may be carried out by the audience inviting the guest, may be carried out by the guest inviting the audience, or may also be carried out by one guest inviting another guest. With the above settings, more diverse interaction manners are provided for users in the live streaming room, improving user experience.

In some embodiments, conditions for the user to send an invitation may also be set, for example, including that a duration of the user being online reaches a threshold, a number of gifts the user gives satisfies a threshold, etc., so as to prevent too many users from sending invitations at the same time, which would cause a heavy burden on the server.

In step S12, under the live streaming room, a new real-time communication channel is created, so that the first user and the second user can perform real-time interaction through the real-time communication channel.

The real-time communication channel (RTC Channel) is a virtual space built based on real-time communication (Real-Time Communication, RTC) technology to support real-time audio and video interaction of multiple people. The real-time communication channel has characteristics of low communication delay and high communication quality, and is suitable for real-time interaction such as co-hosting and video between users.

Users in the real-time communication channel transmit audio and video data to and from the real-time communication channel of the server, to publish their own audio data and subscribe to audio and video data of other users, thereby realizing real-time communication between users.

The first real-time communication channel and the second real-time communication channel belong to the same live streaming room. The first real-time communication channel is configured for communication between co-hosting users, and may be understood as a real-time communication main channel configured to implement a live multi-user chat room in the live streaming room. The second real-time communication channel is configured for communication between the first user and the second user, and may be understood as a real-time communication sub-channel configured to implement interaction between a guest and other users in the live streaming room.

The server described above may include, for example, server functional modules such as a co-hosting server and a sub-channel server. The co-hosting server may manage co-hosting between co-hosting users such as a streamer and a guest in the live streaming room, for example, process requests of the co-hosting users to go on or go off the co-hosting. The sub-channel server may manage a real-time communication sub-channel such as the second real-time communication channel, for example, creation of the real-time communication channel, statistics of users in the real-time communication channel, etc. With the above configuration of the server, service isolation between the main channel and the sub-channel in the server is realized.

In step S13, the server may send a configuration for entering the real-time communication sub-channel to the users.

In some embodiments, the configuration may include a first parameter configured to indicate the live streaming, and the first parameter corresponding to the second real-time communication channel is the same as the first parameter corresponding to the first real-time communication channel.

In other words, the first parameter is a parameter configured to distinguish different live streaming rooms, which may ensure that the user can access the correct live streaming room. Since the first real-time communication channel and the second real-time communication channel belong to the same live streaming room, the first parameter corresponding to the first real-time communication channel is the same as the first parameter corresponding to the second real-time communication channel.

The configuration may further include a second parameter configured to indicate a category of the real-time communication channel, and the second parameter corresponding to the second real-time communication channel is different from the second parameter corresponding to the first real-time communication channel.

In other words, the second parameter is a parameter that distinguishes different categories of real-time communication channels, for example, distinguishing whether the real-time communication channel belongs to a main channel or a sub-channel, thereby ensuring that the user selects a correct real-time communication engine to enter the real-time communication channel. In the above steps, since the first real-time communication channel belongs to the main channel and the second real-time communication channel belongs to the sub-channel, the second parameter corresponding to the second real-time communication channel is different from the second parameter corresponding to the first real-time communication channel.

Further, the live streaming may include a plurality of real-time communication sub-channels, which are configured for communication between different users, not just the second real-time communication channel. For example, in a case where there are other users different from the first user and the second user who wish to interact, a third real-time communication channel for communication between the other users may be created for the live streaming.

The third real-time communication channel also belongs to the real-time communication sub-channel, and therefore, a first parameter and a second parameter corresponding to the third real-time communication channel are the same as the first parameter and the second parameter corresponding to the second real-time communication channel.

In the above case, it may be set that a third parameter corresponding to the third real-time communication channel is different from a third parameter corresponding to the second real-time communication channel, and the third parameter is included in the configuration and configured to indicate a number of the real-time communication channel. Through the above number, different real-time communication sub-channels such as the second real-time communication channel and the third real-time communication channel may be distinguished, so that the user can access the correct real-time communication channel according to the third parameter.

Through the above parameters, the user can accurately enter the real-time communication channel, and confusion between a plurality of real-time communication channels can be avoided, thereby improving user experience.

The flow of the live streaming interaction method in some embodiments of the present disclosure is introduced above with reference to FIG. 1. The live streaming interaction method provided by the present disclosure allows a guest in co-hosting and other users to establish real-time communication by creating a new real-time communication channel under the same live streaming room, and provides more diverse interaction manners for users in the live streaming room, thereby improving user experience.

An example of a system architecture for implementing the above live streaming interaction method is described below with reference to FIG. 2. FIG. 2 shows a schematic diagram of a system architecture according to some embodiments of the present disclosure.

As shown in FIG. 2, a live streaming system 2 may include a main channel architecture 21 and a sub-channel architecture 22. The main channel architecture 21 may include a streamer user terminal 211, a guest user terminal 212, an audience user terminal 213, a co-hosting server 214, a first real-time communication channel 215, and a main channel content delivery network 216. The sub-channel architecture 22 may include a user terminal 221 of a first user, a user terminal 222 of a second user, a sub-channel server 223, and a second real-time communication channel 224.

Based on the above architecture, as shown in FIG. 2, a running process of the main channel, that is, a co-hosting channel, for example, may be that the streamer user terminal 211 and the guest user terminal 212 initiate co-hosting through interaction with the co-hosting server 214. The streamer user terminal 211 and the guest user terminal 212 publish their own audio data and subscribe to audio and video data of other co-hosting users through uplink and downlink of audio and video data with the first real-time communication channel 215, thereby realizing co-hosting between the streamer and the guest. The streamer user terminal 211 or the first real-time communication channel 215 may merge audio and video data of the streamer and the guest, and publish the merged stream of audio and video data to the main channel content delivery network 216. The audience user terminal may pull a stream from the main channel content delivery network to obtain the stream of audio and video data of the streamer and the guest, thereby watching the live streaming.

The user terminals of the above users may include multiple components such as an interaction core component, a connection line service component, and a media service component, which are configured to implement different functions.

The interaction core component may be configured to implement interaction functions such as a bullet screen function, a gift function, or a co-hosting on/off function. The connection line service component may be configured to implement functions such as establishing a connection between the user terminal and the server and between components inside the user terminal. The media service component may be configured to implement functions such as acquisition and processing of audio and video of the user.

The content delivery network (Content Delivery Network, CDN) is a distributed network architecture that caches and delivers content at edge nodes close to users, thereby improving the loading speed and availability of the content, while reducing the load on a server. Compared with real-time communication, the content delivery network has a higher communication delay, but in the case of facing a large number of users, the load of the server may be reduced, and the maintenance cost may be reduced.

By using real-time communication for co-hosting between a small number of users such as the streamer and the guest, and using the content delivery network to deliver the live streaming content to a large number of audiences, the utilization efficiency of the server may be optimized, and the stability of the live streaming may be improved.

The content delivery network described above is only exemplary, rather than restrictive, and it should be understood that the live streaming content may also be distributed in other manners.

As shown in FIG. 2, a running process of the sub-channel, for example, may be that the user terminal 221 of the first user and the user terminal 222 of the second user initiate sub-channel communication through interaction with the sub-channel server 223. The user terminal 221 of the first user and the user terminal 222 of the second user publish their own audio data and subscribe to audio and video data of other real-time communication users through uplink and downlink of audio and video data with the second real-time communication channel 224, thereby realizing sub-channel communication between the first user and the second user.

It may be seen from the system architecture example shown in FIG. 2 that in the system architecture for implementing the live streaming interaction method proposed in the embodiments of the present disclosure, the co-hosting service and the sub-channel communication service may be isolated, which avoids mutual influence between the main channel and the sub-channel.

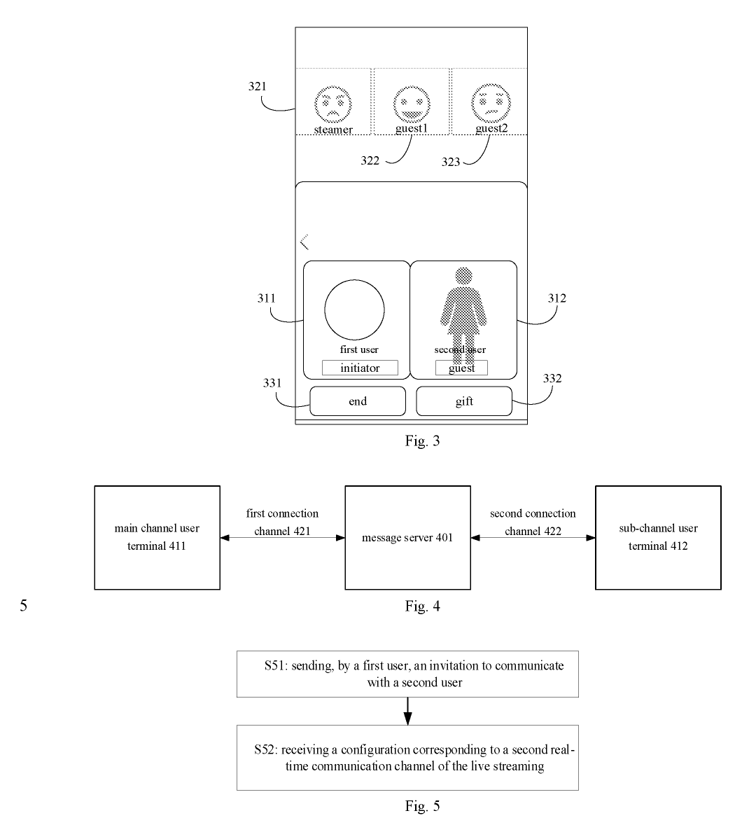

An example of the system architecture according to the embodiments of the present disclosure is introduced above with reference to FIG. 2. Next, an example of a display interface of a user in live streaming interaction is described with reference to FIG. 3. FIG. 3 shows a schematic diagram of a display interface according to some embodiments of the present disclosure.

As shown in FIG. 3, for a communication user in the sub-channel, the display interface may include content from the second real-time communication channel belonging to the sub-channel, such as video content 311 of the first user and video content 312 of the second user. The video data other than the user himself/herself in the audio and video data may be acquired through the second real-time communication channel.

In addition, in a case where the first user or the second user does not wish to perform video interaction, other content may also be displayed as an alternative, such as a user avatar, a user ID, or other preset pictures and texts.

In the example of FIG. 3, the content of the sub-channel live streaming room is displayed in a floating window. Therefore, in addition to displaying the content from the second real-time communication channel belonging to the sub-channel, it is also possible to display content from the first real-time communication channel belonging to the main channel, such as video content 321 of the streamer and video content 322, 323 of the guests.

The above display manner is only exemplary, rather than restrictive, and it should be understood that the live streaming content of the sub-channel may also be displayed in other manners, such as a split-screen display, an immersive display and other display manners.

In addition, as shown in the display interface of FIG. 3, a first control 331 and a second control 332 may also be displayed, where the first control, for example, may be configured to end communication, and the second control, for example, may be configured to give gifts to others in the communication.

In addition to displaying the video content, the user terminal may also play audio from the second real-time communication, so as to realize real-time interaction between users.

The flow and some embodiments of the live streaming interaction method proposed in the present disclosure are introduced above with reference to FIGS. 1-3 . In the above embodiments, through isolation between the main channel and the sub-channel and isolation between each of the real-time communication sub-channels, the guest in co-hosting and other users are allowed to establish exclusive real-time communication, which provides more diverse interaction manners for users in the live streaming room, thereby improving user experience.

Next, how to further realize isolation of live streaming messages between the main channel and the sub-channel in the live streaming interaction method is described. The live streaming messages include, for example, a message that the user receives a gift, a bullet screen message sent by the audience, etc. The server realizes message distribution through a connection channel between a message server and the user in the live streaming room.

In some embodiments, a first message related to the first real-time communication channel and a second message related to the second real-time communication channel may be distributed through different connection channels between a message server and the users of the live streaming, respectively. FIG. 4 shows a schematic diagram of connection channels according to some embodiments of the present disclosure.

As shown in FIG. 4, a message server 401 may establish a first connection channel 421 with a main channel user terminal 411, and establish a second connection channel 422 with a sub-channel user terminal 412.

The connection channel may be, for example, a link or a path between the server and the user terminal, including, for example, a physical link based on an actual hardware connection and a logical link based on a network protocol, which is configured to transmit messages between the message server and the user terminal.

In the above embodiments, the message server uses different physical connection channels, for example, the message server may establish the first connection channel with the user terminal in the first real-time room, and establish the second connection channel with the user terminal in the second real-time communication channel, so as to distribute the first message and the second message, respectively.

With the above configuration, the messages between the first real-time communication channel and the second real-time communication channel will not interfere with each other, and service isolation between the main channel messages and the sub-channel messages is realized.

In some other embodiments, the first message related to the first real-time communication channel and the second message related to the second real-time communication channel may be distributed through a same connection channel between the message server and the users of the live streaming, wherein each of the first message and the second message include an identification configured to indicate a message source.

In the above embodiments, the message server may also distribute the first message and the second message by reusing a same physical connection channel, and each of the distributed messages include an identification configured to indicate the message source, through which the user terminal may be instructed to display the corresponding message. For example, after receiving the first message and the second message, the user terminal in the first real-time communication channel may only display the first message related to the first real-time communication channel according to the identification; similarly, after receiving the first message and the second message, the user terminal in the second real-time communication channel may only display the second message according to the identification.

With the above configuration, the user in the sub live streaming room may be allowed to reuse the message channel of the main live streaming room without newly adding a physical connection, which avoids excessive connections from increasing the load of the server.

It is introduced above how to further realize message isolation in the live streaming interaction method proposed in the present disclosure, in addition to isolation between the main channel and the sub-channel and isolation between each of the real-time communication sub-channels.

After a new real-time communication channel is added, in order to ensure the experience of communication users, it is necessary to determine the connection state of each user and perform processing in the case of an abnormality. Next, how to determine the connection state of the user is described.

In some embodiments, the live streaming interaction method may further include: determining a connection state of a user in the second real-time communication channel according to connection line user information and actual communication user information of the second real-time communication channel.

The connection line user information refers to, for example, a connection line user list stored on the server, and the connection line user list may be updated when a preset condition is satisfied.

The preset condition may include at least one of: receiving a message of entering the sub-channel or a message of leaving the sub-channel sent by the user terminal, determining that the connection state of the user is abnormal, or receiving a gift message queue. In the above cases, the user list in the sub-channel may be updated, and the list of users who should be communicating may be determined from the server.

The actual communication user information refers to, for example, a list of users who are actually communicating in the real-time communication channel. The actual communication user information of the real-time communication channel may be determined by whether the user and the real-time communication channel are performing uplink and downlink of audio and video data.

Through the comparison of the above information, whether the user information stored on the server is consistent with the user information of the actual communication may be determined, thereby determining the connection state of the user. For example, if the connection line user information indicates that there should be four users communicating in the second real-time communication channel, while the actual communication user information indicates that only three users are communicating, it may be determined that the connection of one user is abnormal.

In the above manner, the connection state of the user in the live streaming room may be accurately determined, so that information such as the list of communicating users may be updated in real time, and the utilization efficiency of server resources may be improved.

In the embodiments described above, the content related to the first user and the second user in the live streaming interaction method is disclosed in terms of service isolation, room isolation, message isolation, and connection state determination. Next, how to play the content of the sub-channel for other users in the live streaming room, so as to enable the other users to watch the real-time communication between the first user and the second user, is further described.

In some embodiments, the live streaming interaction method may further include: sending, in response to receiving a stream pulling request sent by a third user of the live streaming, to the third user, stream data of a merged stream of audio and video data of a real-time communication channel corresponding to the stream pulling request, wherein the stream data includes a stream address of the merged stream.

The third user may be a streamer, a guest, or an audience in the live streaming room. In a case where the third user wishes to watch the live streaming in the live streaming room, the third user may send the stream pulling request to the server, so as to acquire and play the merged stream of audio and video data to watch the live streaming.

Similar to the main channel, in the sub-channel, audio and video of the real-time communication channel may also be merged, so as to provide the merged stream of audio and video for other users to watch. For example, the server may directly merge the audio and video data in the real-time communication sub-channel, and publish the merged stream of audio and video data to a sub-channel content delivery network.

In some embodiments, the stream data may further include an identification configured to indicate a source of the merged stream, so as to distinguish the merged stream from the main channel and the merged stream from the sub-channel. Based on the above distinction, the user may be allowed to use different stream pulling manners for different merged streams.

In some cases, the communication duration of the real-time communication sub-channel may be limited, for example, only 5 minutes of real-time communication is supported, and the real-time communication room will be closed after 5 minutes. In order to prevent users watching the merged stream of the sub-channel from missing the content of the sub-channel, a low-latency stream pulling solution is required. For example, for the merged stream of the sub-channel, the real-time messaging (Real-Time Messaging, RTM) protocol may be used to pull the stream, and for the merged stream of the main channel, the HTTP live streaming (HTTP Live Streaming, HLS) protocol may be used to pull the stream. With the above configuration, user experience may be improved while avoiding an excessive load on the server.

In addition, based on the identification described above, the merged stream of the main channel and the merged stream of the sub-channel may be connected to different review models, which improves the flexibility of live streaming.

The above embodiments introduce the live streaming interaction method proposed in the present disclosure from the perspective of the server. The live streaming interaction method allows a guest in co-hosting and other users to establish real-time communication by creating a new real-time communication channel under the same live streaming room, which further meets social needs of users, thereby improving user experience.

Next, the live streaming interaction method proposed in the present disclosure is introduced from the perspective of the user terminal with reference to FIG. 5. FIG. 5 shows a flowchart of a live streaming interaction method according to some other embodiments of the present disclosure.

As shown in FIG. 5, the live streaming interaction method applied to a user terminal includes: Step S51, sending, by a first user, an invitation to communicate with a second user, wherein at least one of the first user or the second user is a co-hosting user in a first real-time communication channel of a live streaming; and Step S52, receiving a configuration corresponding to a second real-time communication channel of the live streaming, to enter the second real-time communication channel according to the configuration, wherein the second real-time communication channel is different from the first real-time communication channel, and is configured for communication between the first user and the second user.

In the above steps, the invitation sent by the user terminal may be sent to the second user through the server, and the configuration received by the user terminal may also be sent by the server.

The concepts of the first user, the second user, the real-time communication channel, etc. in the above steps are consistent with the corresponding concepts in the live streaming interaction method described in FIG. 1, and are not repeated here.

The live streaming interaction method proposed in the present disclosure allows a guest in co-hosting and other users to establish real-time communication through a real-time communication channel newly created under the same live streaming room, which further meets social needs of the users, thereby improving user experience.

Next, how to achieve isolation of real-time communication engines through configuration, so as to use different real-time communication engines to enter different real-time communication channels is described.

In some embodiments, the live streaming interaction method may further include: creating a second real-time communication engine for entering the second real-time communication channel according to a first parameter configured to indicate the live streaming and a second parameter configured to indicate a category of the real-time communication channel in the configuration, wherein the second real-time communication engine is different from a first real-time communication engine configured to enter the first real-time communication channel.

As described above, the first parameter is a parameter configured to distinguish different live streaming rooms, which may ensure that the user can access the correct live streaming room. Since the first real-time communication channel and the second real-time communication channel belong to the same live streaming room, the first parameter corresponding to the first real-time communication channel is the same as the first parameter corresponding to the second real-time communication channel.

The second parameter is a parameter that distinguishes different categories of real-time communication channels, for example, distinguishing whether the real-time communication channel belongs to a main channel or a sub-channel, thereby ensuring that the user selects a correct real-time communication engine to enter the real-time communication channel. In the above steps, since the first real-time communication channel belongs to the main channel and the second real-time communication channel belongs to the sub-channel, the second parameter corresponding to the second real-time communication channel is different from the second parameter corresponding to the first real-time communication channel.

After receiving the above parameters, the user terminal may create a real-time communication engine for entering the real-time communication channel according to the above parameters.

The real-time communication engine (Real-Time Communication Engine) is a technical framework used to support low-latency and high-concurrency real-time communication, and is widely used in scenarios such as live streaming and instant messaging. The real-time communication engine ensures that data can be transmitted between users quickly and stably by optimizing network transmission and resource management, thereby providing a smooth interactive experience.

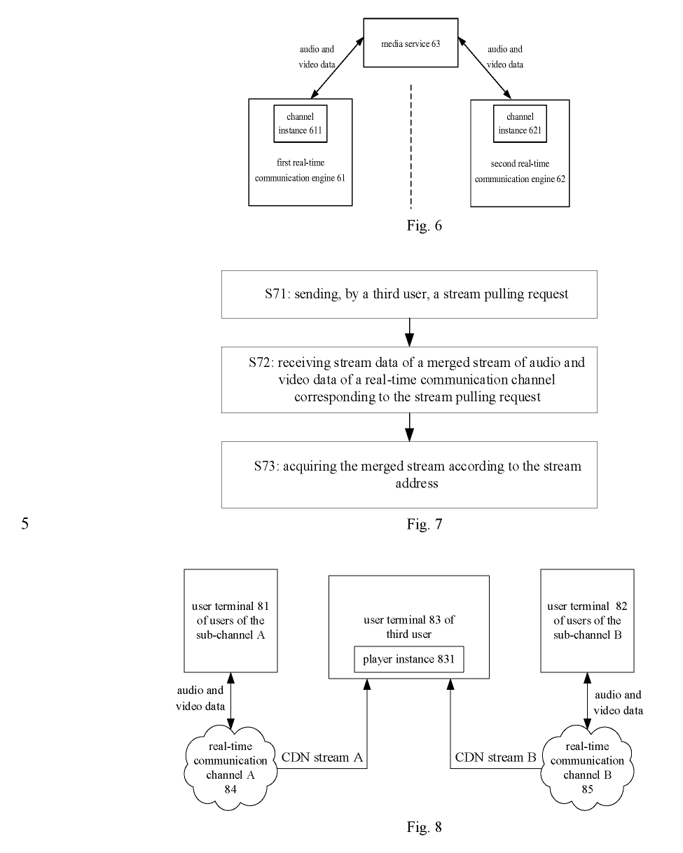

FIG. 6 shows a schematic diagram of a user terminal system architecture according to some embodiments of the present disclosure. As shown in FIG. 6, an example of the user terminal system architecture may include a first real-time communication engine 61, a second real-time communication engine 62, and a media service 63.

The first real-time communication engine 61 may be configured to enter the first real-time communication channel belonging to the main channel, and the second real-time communication engine 62 may be configured to enter the second real-time communication channel belonging to the sub-channel. The media service 63 refers to a module in the user terminal, configured to implement functions such as audio and video data acquisition. After the media service acquires audio and video data of the user, the audio and video data may be sent to the real-time communication engine, so as to perform uplink and downlink transmission of audio and video data with the real-time communication channel.

The first real-time communication engine 61 and the second real-time communication engine 62 may include a channel instance 611 and a channel instance 621, respectively. When entering the real-time communication channel, a channel instance corresponding to the real-time communication channel may be selected from the channel instances for access.

It should be understood that the real-time communication engine may further include information such as configuration parameters, so as to ensure the success of the user's access and improve user experience.

It may be seen from FIG. 6 that different real-time communication engines may also be isolated, which avoids mutual interference between the main channel and the sub-channel, and realizes service isolation.

It should be understood that in some embodiments, in a case where the user in the real-time communication sub-channel is not a co-hosting user in the main live streaming room, the user terminal may not have the first real-time communication engine, thereby saving system resources.

Further, as described above, in a case where there are other users who wish to have different connection line, different real-time communication sub-channels may be created under the same live streaming room. In this case, the live streaming interaction method may further include: determining a channel instance corresponding to a third parameter in the real-time communication engine according to the third parameter configured to indicate a number of the real-time communication channel in the configuration; and entering the second real-time communication channel through the channel instance.

Through the number configured to indicate the real-time communication channel, different real-time communication sub-channels such as the second real-time communication channel and a third real-time communication channel may be distinguished. The third parameter configured to indicate the number is included in the configuration, so that the user can access the correct real-time communication channel according to the third parameter.

The second real-time communication engine created by the user terminal may include a plurality of channel instances. After receiving the third parameter, the user terminal may select a corresponding room instance in the real-time communication engine according to the third parameter, and enter the corresponding real-time communication channel, and perform uplink and downlink transmission of audio and video data.

The specific content and processing manner of the configuration in the live streaming interaction method are introduced above. Next, how the user terminal processes the distributed message after receiving it in the live streaming interaction method is described.

In some embodiments, the live streaming interaction streaming method further includes: receiving, from a message server, a first message related to the first real-time communication channel and a second message related to the second real-time communication channel through a same connection channel, wherein each of the first message and the second message include an identification configured to indicate a message source; and displaying a corresponding message according to the identification.

As described above, the message server may also distribute the first message and the second message by reusing the same physical connection channel, and the message is accompanied by the corresponding identification.

The user terminal may be instructed to display the corresponding message through the identification. For example, after receiving the first message and the second message, the user terminal in the first real-time communication channel may only display the first message related to the first real-time communication channel according to the identification; after receiving the first message and the second message, the user terminal in the second real-time communication channel may only display the second message according to the identification.

Similarly, after receiving the first message and the second message, the user terminal watching the merged stream of the main channel may also only display the first message related to the first real-time communication channel according to the identification; after receiving the first message and the second message, the user terminal watching the merged stream of the sub-channel may only display the second message according to the identification.

With the above settings, it is possible to avoid mutual interference of messages between the main channel and the sub-channel, to achieve service isolation at the message level, and to improve user experience.

The above embodiments describe how the live streaming interaction method of the present disclosure achieves isolation at the message level. Next, how the user terminal plays the live streaming content of the sub-channel for the user is described with reference to FIG. 7. FIG. 7 shows a flowchart of a live streaming interaction method according to still some embodiments of the present disclosure.

As shown in FIG. 7, the live streaming interaction method may further include: Step S71, sending, by a third user, a stream pulling request; Step S72, receiving stream data of a merged stream of audio and video data of a real-time communication channel corresponding to the stream pulling request, wherein the stream data includes a stream address of the merged stream; and Step S73, acquiring the merged stream according to the stream address.

The above stream pulling request may include a source of the merged stream that is desired to be acquired, for example, it may indicate that the merged stream for which stream pulling is desired is a merged stream of audio and video data of the first real-time communication channel belonging to the main channel, or a merged stream of audio and video data of the second real-time communication channel belonging to the sub-channel.

After receiving the stream pulling request, the sub-channel server may send the stream data of the merged stream corresponding to the stream pulling request to the third user, for example, the stream data includes the stream address of the merged stream, so that the user terminal may acquire the merged stream according to the stream data.

Further, as described above, the real-time communication sub-channel may be more sensitive to time. For example, in some cases, the communication duration of the real-time communication sub-channel may be limited, for example, only 5 minutes of real-time communication is supported, and the real-time communication room will be closed after 5 minutes.

In order to prevent users watching the merged stream of the sub-channel from missing the content of the sub-channel, different stream pulling manners may also be adopted for different merged streams. For the merged stream of the sub-channel, a low-latency stream pulling solution is required.

In some embodiments, in response to the identification in the stream data, which is configured to indicate the source of the merged stream, indicating that the source of the merged stream is the first real-time communication channel, the merged stream is acquired according to the stream address in a first stream pulling manner. The first stream pulling manner is, for example, stream pulling using the HLS protocol.

In some other embodiments, in response to the identification indicating that the source of the merged stream is the second real-time communication channel, the merged stream is acquired according to the stream address in a second stream pulling manner, wherein the second stream pulling manner has a lower stream pulling latency than the first stream pulling manner. The second stream pulling manner is, for example, stream pulling using the RTM protocol.

The identification configured to indicate the source of the merged stream is included in the stream data, so as to distinguish the merged stream from the main channel and the merged stream from the sub-channel. Based on the above distinction, the user may be allowed to use different stream pulling manners for different merged streams. With the above configuration, user experience may be improved while avoiding an excessive load on the server.

In addition, based on the identification described above, the merged stream of the main channel and the merged stream of the sub-channel may be connected to different review models, which improves the flexibility of live streaming.

As described above, in the live streaming interaction method proposed in the present disclosure, different processing manners may be adopted for the merged stream of the main channel and the sub-channel. In addition, in the case where there are a plurality of sub-channels, it is also possible to switch between the sub-channels by reusing a player instance and switching a stream pulling address, thereby improving user experience.

FIG. 8 shows a schematic diagram of a stream pulling process according to some embodiments of the present disclosure. As shown in FIG. 8, the sub-channel may include a sub-channel A and a sub-channel B.

Users of the sub-channel A communicate through interaction between a user terminal 81 and a real-time communication channel A 84, and the real-time communication channel A generates a merged stream of audio and video data, i.e., a CDN stream A. Users of the sub-channel B communicate through interaction between a user terminal 82 and a real-time communication channel B 85, and the real-time communication channel B generates a merged stream of audio and video data, i.e., a CDN stream B.

The above CDN streams correspond to different stream addresses, respectively. A third user watching the live streaming of the sub-channel may acquire and play the live streaming content of the sub-channel A from a stream address A or acquire and play the live streaming content of the sub-channel B from a stream address B through the same player instance 831, .

In other words, when switching between different sub-channels, the third user does not need to create a new player instance, and only needs to switch the stream address for stream pulling, which saves user resources and improves user experience.

As introduced above, for different merged streams, different processing manners may be adopted for playing, so as to improve user experience. In addition, different processing manners may also be adopted for different third users, thereby improving the flexibility of live streaming.

In some embodiments, in response to the third user being a streamer user among the co-hosting users, audio publishing is stopped in the first real-time communication channel.

In other words, in a case where the third user is the streamer, the third user may stop publishing audio in the first real-time communication channel, but keep publishing video, so as to ensure the viewing experience of the audience in the first real-time communication channel.

In addition, the third user may also keep subscribing to audio and video data of other users in the first real-time communication channel, so as to merge audio and video data of the first real-time communication channel through the user terminal, thereby allowing other audiences to watch. At the user terminal of the third user, the audio in the audio and video data of the first real-time communication channel may be muted, and only the audio and video data of the second real-time communication channel obtained by stream pulling is played to avoid interference.

The above settings realize decoupling between the playback volume of real-time communication and the volume of the merged stream. Although the streamer user terminal does not play sound, the merged stream generated by the streamer client will carry sound.

In some other embodiments, in response to the third user being a non-streamer user among the co-hosting users, audio and video publishing is stopped in the first real-time communication channel, and audio subscription to other co-hosting users is stopped.

In other words, in a case where the third user is a guest, the third user may stop publishing audio and video in the first real-time communication channel, and stop subscribing to the audio in the first real-time communication channel, that is, temporarily exit from the first communication room, so as to avoid mutual interference between different audio and video streams.

With the above settings, the user's playing scheme may be more flexible, so as to meet more diverse user needs and improve user experience.

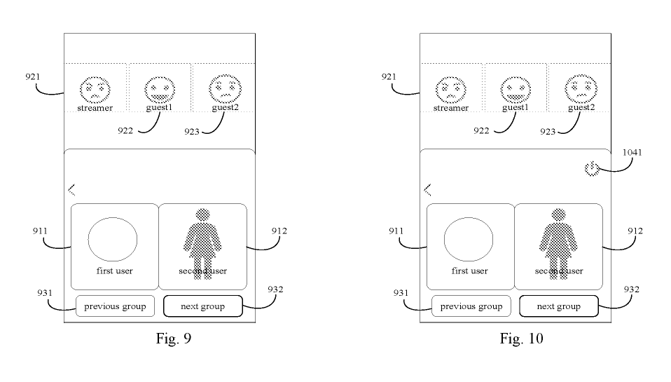

The watching process of the third user for the sub-channel live streaming room is introduced above. Next, an example of displaying the sub-channel live streaming room is described with reference to FIG. 9 and FIG. 10.

FIG. 9 shows a schematic diagram of a display interface according to some other embodiments of the present disclosure.

As shown in FIG. 9, in a case where the third user is an audience or a guest, the playing interface of the third user may include content from the second real-time communication channel belonging to the sub-channel, such as video data 911 of the first user and video data 912 of the second user. The audio and video data may be acquired from a node such as a content delivery network by stream pulling.

In the example of FIG. 9, the content of the sub-channel live streaming room is displayed in a floating window, therefore, in addition to displaying the content from the second real-time communication channel belonging to the sub-channel, it is also possible to display content from the first real-time communication channel belonging to the main channel, such as video data 921 of the streamer and video data 922, 923 of the guests.

The above display manner is only exemplary, rather than restrictive, and it should be understood that the live streaming content of the sub-channel may also be displayed in other manners, for example, in an immersive manner.

In addition, in the case where there are a plurality of real-time communication sub-channels, the display interface may further include a third control 931 and a fourth control 932. The third control and the fourth control, for example, may be configured to switch between different sub-channel live streaming rooms.

In some embodiments, for the user terminal, the above switching may be realized by switching stream pulling addresses, in other words, for different sub-channel live streaming rooms, the user terminal does not need to create a new player instance, may reuse the same player instance, and only needs to switch the addresses for stream pulling.

With the above settings, resources of the user terminal may be effectively saved, and user experience may be improved.

FIG. 10 shows a schematic diagram of a display interface according to still some embodiments of the present disclosure.

As shown in FIG. 10, in a case where the third user is the host, on the basis of the display interface shown in FIG. 9, a fifth control 1041 may also be included, which is configured to end the sub-channel live streaming room.

With the above settings, it is possible to distinguish display interfaces of different users, and provide different functions for the display interfaces of different users, so as to meet more diverse user needs and improve user experience.

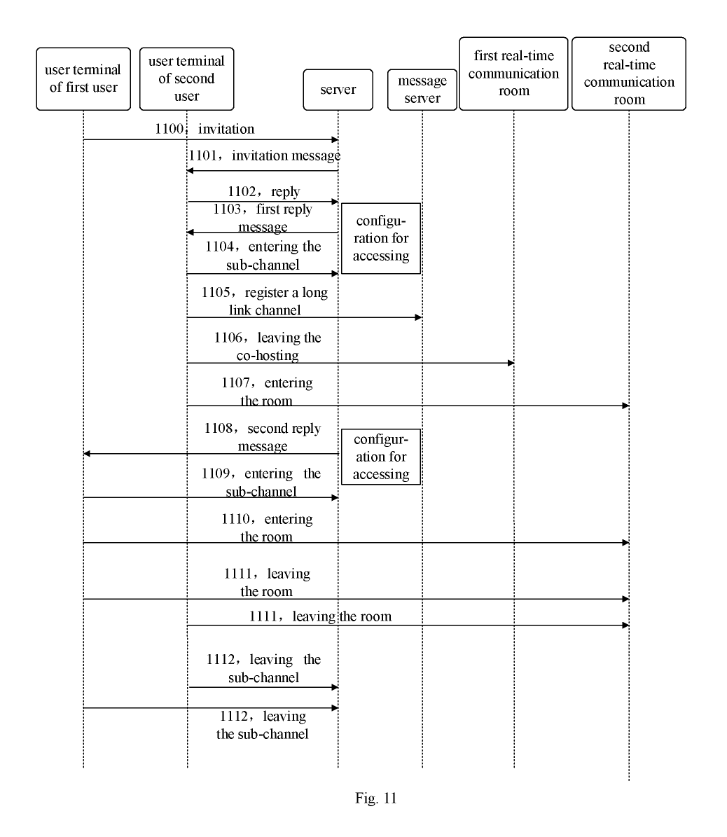

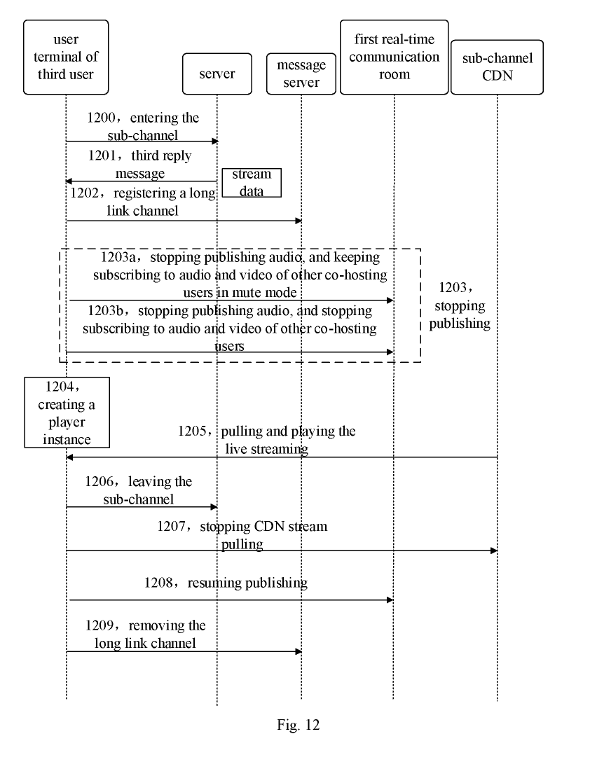

The live streaming interaction method proposed in the present disclosure is introduced above from multiple aspects based on FIGS. 1-10 . Next, examples of signal flowcharts of the live streaming interaction method in different scenarios are described based on FIGS. 11-12 .

FIG. 11 shows a signaling flowchart of a live streaming interaction method according to some embodiments of the present disclosure. As shown in FIG. 11, the live streaming interaction method may include processes 1100 to 1112, , which are related to a first user and a second user in a sub-channel. In the example shown in FIG. 11, the first user as the inviter is an audience, and the second user as the invitee is a guest.

In process 1100, the user terminal of the first user sends an invitation to communicate with the second user to the server, for example, the sub-channel connection line service in the user terminal may call the /guest_link_invite interface to send the invitation to the sub-channel server.

In the example shown in FIG. 11, the connection line service of the user terminal includes a main channel connection line service and a sub-channel connection line service, and the above connection line services belong to service distinction, which may be implemented through the same physical architecture.

In process 1101, the server sends an invitation message to the user terminal of the second user, for example, may send the invitation message to the sub-channel connection line service in the user terminal of the second user, thereby triggering an invitation event, so that the second user may select whether to agree.

In process 1102, the user terminal of the second user sends a reply to the server, indicating that the second user agrees to communicate, for example, by calling the /guest_link_reply interface.

In process 1103, the server returns a first reply message to the user terminal of the second user, which may carry a configuration for accessing the second real-time communication channel.

In process 1104, the user terminal of the second user reports to the server that it enters the sub-channel, for example, by calling the /guest_link_join_linked_channel interface. After receiving the message of entering the sub-channel, the server may update a list of users stored in the server, so as to determine a connection state of the communication users subsequently.

In process 1105, the user terminals of the first user and the second user may register a long link channel with the message server, which is configured to receive messages distributed by the message server, etc.

In process 1106, a guest among the first user and the second user may perform a process of leaving the co-hosting, and send a message of leaving the room to the first real-time communication channel, for example, by calling the /stopinteract interface, to stop uplink and downlink transmission between the user and the real-time communication channel.

It should be understood that process 1106 may only be executed by the guest among the first user and the second user, and the audience does not need to perform the process of leaving the co-hosting.

In process 1107, the second user enters the second real-time communication channel, for example, by calling the /joinroom interface to publish audio and video data of the second user.

In process 1108, the server may send a second reply message to the user terminal of the first user, and carry the same configuration in the second reply message, so that the first user may enter the second real-time communication channel.

In process 1109, similar to the second user, the user terminal of the first user reports to the server that it enters the sub-channel, for example, by calling the /guest_link_join_linked_channel interface.

In process 1110, the first user enters the second real-time communication channel, for example, by calling the /joinroom interface similar to the second user, to publish audio and video data of the first user.

In process 1111, under certain conditions, the first user and the second user leave the second real-time communication channel, and the communication between the first user and the second user ends.

Conditions for the end of communication include, for example: an active end scenario such as the first user or the second user actively hanging up, the streamer in the live streaming room closing the second real-time communication channel or closing the guest co-hosting function, etc., the second real-time communication channel sending a callback of the other party leaving the room to the user terminal, the communication duration reaching a preset duration and other conditions.

In process 1112, the user terminal of the first user and the user terminal of the second user report to the server that they leave the sub-channel, for example, by calling the /guest_link_join_linked_channel interface.

The signaling flowchart related to the user of the real-time communication sub-channel in the live streaming interaction method is introduced above with reference to FIG. 11. The live streaming interaction method proposed in the present disclosure allows the guest in co-hosting and other users to establish real-time communication by creating a new real-time communication channel under the same live streaming room, which provides more diverse interaction manners for users in the live streaming room, thereby improving user experience.

Next, a signaling flowchart related to a user watching the live streaming of the sub-channel is described with reference to FIG. 12. FIG. 12 shows a signaling flowchart of a live streaming interaction method according to some other embodiments of the present disclosure. As shown in FIG. 12, the live streaming interaction method may include processes 1200 to 1209.

In process 1200, in response to a third user wishing to watch the live streaming of the sub-channel, a user terminal of the third user sends a request to enter the sub-channel to the server, for example, by calling the /guest_link_enter_channel interface.

After receiving the above request, the server may also update a list of viewing users watching the live streaming of the sub-channel, thereby counting the number of people watching the live streaming, so as to further optimize live streaming resources and improve user experience.

In process 1201, the server sends a third reply message to the user terminal of the third user, and the third reply message may include stream data of a merged stream of the sub-channel, for example, a stream address of the merged stream.

In the case where a plurality of real-time communication sub-channels are included, the stream data of the merged stream of the live streaming room corresponding to the request of the third user will be sent.

In process 1202, the user terminal of the third user may register a long link channel with the message server, which is configured to receive messages distributed by the message server, etc.

In process 1203, in a case where the third user is a streamer or a guest, publishing of the first real-time communication channel is stopped.

In a case where the third user is the streamer, process 1203a is executed to stop publishing own audio, and keep subscribing to audio and video of other co-hosting users in a mute mode.

In a case where the third user is the guest, process 1203b is executed to stop publishing own audio and video, and stop subscribing to audio of other co-hosting users.

In process 1204, the user terminal of the third user creates a player instance, and the player instance is configured to play the live streaming content of the sub-channel.

In process 1205, the user terminal pulls and plays the live streaming of the sub-channel from a sub-channel CDN through the stream data of the merged stream.

In process 1206, under certain conditions, the server is reported that the sub-channel is left, for example, by calling the /guest_link_leave_channel interface.

Conditions for reporting to leave the sub-channel include, for example: an active end scenario such as actively leaving, the streamer in the live streaming room closing the sub-channel or closing the guest co-hosting function, etc., the message server detecting an abnormality in the connection state of the third user and other conditions.

After leaving the sub-channel, the player resources of the sub-channel in the user terminal of the third user may be cleared to avoid freezing and improve user experience.

In process 1207, CDN stream pulling is stopped, for example, by calling the /stopCDNstream interface.

In process 1208, in the case where the third user is the streamer or the guest, the publishing of the first real-time communication channel is resumed.

In process 1209, the user terminal of the third user may remove the long link channel with the message server, and stop receiving corresponding messages.

The signaling flowchart related to the user watching the live streaming of the sub-channel in the live streaming interaction method is introduced above with reference to FIG. 12. The live streaming interaction method proposed in the present disclosure provides the live streaming content of the sub-channel by merging and publishing content of the newly created real-time communication channel, and allows users other than the real-time communication users to watch, which further meets diverse user needs and improves user experience.

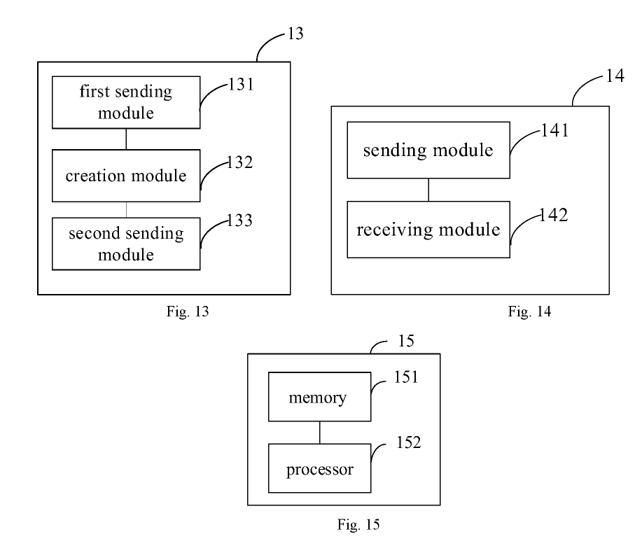

The above is the live streaming interaction method provided by the embodiments of the present disclosure. A server and a user device according to embodiments of the present disclosure are described below with reference to FIGS. 13 and 14, which are configured to implement the embodiments in the above live streaming interaction method. FIG. 13 shows a block diagram of a server according to some embodiments of the present disclosure.

As shown in FIG. 13, the server 13 includes: a first sending module 131 configured to send an invitation to a second user, in response to receiving a request for communicating with the second user sent by a first user, wherein at least one of the first user or the second user is a co-hosting user in a first real-time communication channel of a live streaming; a creation module 132 configured to create, for the live streaming, a second real-time communication channel for communication between the first user and the second user, wherein the second real-time communication channel is different from the first real-time communication channel; and a second sending module 133 configured to send a configuration corresponding to the second real-time communication channel to the first user and the second user, so that the first user and the second user enter the second real-time communication channel according to the configuration.

The first sending module 131 of the server 13 may be configured to perform Step S11 of FIG. 1, for example. The creation module 132 of the server 13 may be configured to perform Step S12 of FIG. 1, for example. The second sending module 133 of the server 13 may be configured to perform Step S13 of FIG. 1, for example.

The above server provided by the present disclosure allows the guest in co-hosting and other users to establish real-time communication by creating a new real-time communication sub-channel in the same live streaming room architecture, which further meets social needs of the users, thereby improving user experience.

FIG. 14 is a block diagram illustrating a user device according to some embodiments of the present disclosure.

As shown in FIG. 14, the user device 14 includes: a sending module 141 configured to send, by a first user, an invitation to communicate with a second user, wherein at least one of the first user or the second user is a co-hosting user in a first real-time communication channel of a live streaming; and a receiving module 142 configured to receive a configuration corresponding to a second real-time communication channel of the live streaming, to enter the second real-time communication channel according to the configuration, wherein the second real-time communication channel is different from the first real-time communication channel, and is configured for communication between the first user and the second user.

The sending module 141 of the user device 14 may be configured to perform Step S61 of FIG. 5, for example. The receiving module 142 of the user device 14 may be configured to perform Step S62 of FIG. 5, for example.

The above user device provided by the present disclosure allows a user to watch the live streaming of the sub-channel through the configuration sent by the server, which further meets diverse user needs and improves user experience.

FIG. 15 shows a block diagram of an electronic device according to some embodiments of the present disclosure.

As shown in FIG. 15, the electronic device 15 includes: at least one memory 151; and at least one processor 152 coupled to the at least one memory 151, the at least one processor 152 configured to, based on instructions stored in the at least one memory 151, carry out the live streaming interaction method according to any of the above embodiments.

The memory 151 is configured to store one or more computer-readable instructions. The memory 151 may include any combination of various forms of computer-readable storage medium, such as a volatile memory and/or a non-volatile memory, including but not limited to a random access memory (RAM), a dynamic random access memory (DRAM), a static random access memory (SRAM), a read-only memory (ROM), and a flash memory. The memory 151 may store, for example, an operating system, an application, a boot loader (Boot Loader), a database, and other programs, and may also store various applications, various data, and the like.

The processor 152 is configured to run computer-readable instructions to implement the live streaming interaction method according to any of the above embodiments. For the specific implementation of each step of the method, reference may be made to the above embodiments, such as the steps in FIG. 1, FIGS. 5 and 7, and the repeated parts are not described herein.

The above electronic device of the present disclosure, by creating a new real-time communication sub-channel in the same live streaming room architecture, allows the guest in co-hosting and other users to establish real-time communication, which further meets social needs of the users, thereby improving user experience.

The processor 152 may be embodied as various processing apparatuses, such as a central processing unit (CPU), a network processor (NP), etc.; and may also be a digital signal processor (DSP), an application specific integrated circuit (ASIC), a field programmable gate array (FPGA) or other programmable logic devices, a discrete gate or transistor logic device, and a discrete hardware component. The central processing unit (CPU) may have an X86 or ARM architecture or the like.

The processor 152 and the memory 151 may directly or indirectly communicate with each other. For example, the processor 152 and the memory 151 may communicate through a network. The network may include a wireless network, a wired network, and/or any combination of a wireless network and a wired network. The processor 152 and the memory 151 may also communicate with each other through a system bus, which is not limited in the present disclosure.

It should be noted that the components of the electronic device 15 shown in FIG. 15 are only exemplary and non-restrictive, and the electronic device 15 may have other components according to actual application needs. The processor 152 may control other components in the electronic device 15 to perform desired functions.

The electronic device 15 may be implemented by means of software, firmware, and/or hardware, and may be integrated in an apparatus installed with relevant applications.

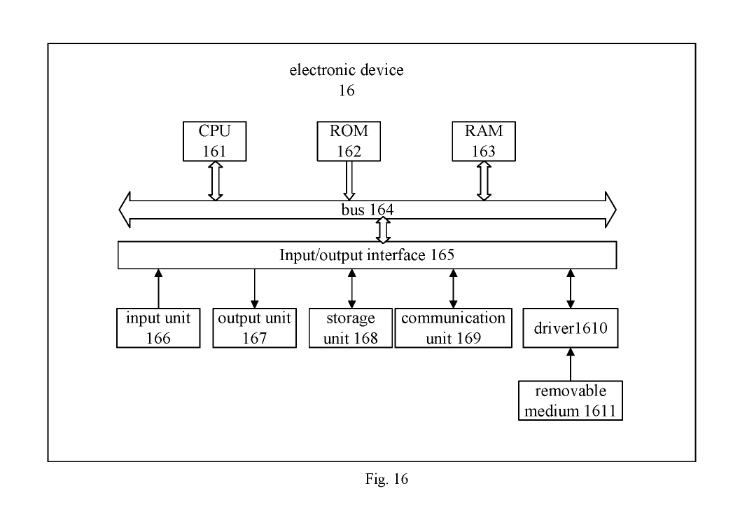

FIG. 16 shows a block diagram of an electronic device according to some other embodiments of the present disclosure.

The electronic device 16 shown in FIG. 16 may be a computer system with a dedicated hardware structure, which may perform corresponding functions when installed with relevant applications.

The electronic device includes, but is not limited to, mobile terminals such as a smartphone, a notebook computer, a personal digital assistant (Personal Digital Assistant, PDA), a tablet computer (Tablet Personal Computer, Tablet PC), a PMP (portable multimedia player), a vehicle-mounted terminal (such as a vehicle navigation terminal), and a wearable device, and fixed terminals such as a digital TV and a desktop computer.

As shown in FIG. 16, a central processing unit (CPU) 161 executes various processes according to a program stored in a read-only memory (ROM) 162 or a program loaded from a storage unit 168 into a random access memory (RAM) 163. In the RAM 163, data required when the CPU 161 executes various processes and the like is stored as needed. The central processing unit is only exemplary, and it may be other types of processors, such as the various processors described above. The ROM 162, the RAM 163, and the storage unit 168 may be various forms of computer-readable storage medium. It should be noted that although the ROM 162, the RAM 163, and the storage unit 168 are shown separately in FIG. 16, one or more of them may be combined or located in the same or different memories or memory modules.

The CPU 161, the ROM 162, and the RAM 163 are connected to each other via a bus 164. An input/output interface 165 is also connected to the bus 164.

The following components are connected to the input/output interface 165: an input unit 166 such as a touch screen, a touchpad, a keyboard, a mouse, an image sensor, a microphone, an accelerometer, and a gyroscope; an output unit 167 including a display such as a cathode ray tube (CRT), a liquid crystal display (LCD), a speaker, a vibrator, or the like; the storage unit 168 including a hard disk, a magnetic tape, or the like; and a communication unit 169 including a network interface card such as a LAN card and a modem. The communication unit 169 allows communication processing to be executed via a network such as Internet. It is easy to understand that although some components in the electronic device 16 are shown to communicate through the bus 164 in FIG. 16, they may also communicate through a network or other means, where the network may include a wireless network, a wired network, and/or any combination of a wireless network and a wired network.

A driver 1610 is also connected to the input/output interface 165 as needed. A removable medium 1611 such as a magnetic disk, an optical disc, a magneto-optical disc, and a semiconductor memory is installed on the driver 1610 as needed, so that a computer program read therefrom is installed into the storage unit 168 as needed.

In the case of implementing the above series of processes by means of software, a program constituting the software may be installed from a network such as Internet or a storage medium such as the removable medium 1611.

According to the embodiments of the present disclosure, the process described above with reference to the flowchart may be implemented as a computer software program. For example, some embodiments of the present disclosure include a computer program product, which, when running on a computer, causes the computer to implement the live streaming interaction method according to any of the above embodiments. The computer program product includes computer instructions carried on a computer-readable medium, including program code for carrying out the method shown in the flowchart. In such an embodiment, the computer instructions may be downloaded and installed from a network through the communication unit 169, or installed from the storage unit 168, or installed from the ROM 162. When the computer program is executed by the CPU 161, the method of the embodiment of the present disclosure is executed.

The above live streaming interaction method, by creating a new real-time communication sub-channel in the same live streaming room architecture, allows the guest in co-hosting and other users to establish real-time communication, which further meets social needs of the users, thereby improving user experience.

It should be noted that, in the context of the present disclosure, a computer-readable medium may be a tangible medium that may contain or store a program for use by or in connection with an instruction execution system, apparatus, or device.

The computer-readable medium may be a computer-readable storage medium, a computer-readable signal medium, or any combination of the two.

The computer-readable storage medium includes, but is not limited to, an electrical, magnetic, optical, electromagnetic, infrared, or semiconductor system, apparatus, or device, or any suitable combination of the above. More specific examples of the computer-readable storage medium may include, but are not limited to: an electrically connected portable computer disk with one or more wires, a hard disk, a random access memory (RAM), a read-only memory (ROM), an erasable programmable read-only memory (EPROM or flash memory), an optical fiber, a portable compact disk read-only memory (CD-ROM), an optical storage device, a magnetic storage device, or any suitable combination of the above. In the present disclosure, the computer-readable storage medium may be any tangible medium that contains or stores a program, and the program may be used by or in connection with an instruction execution system, apparatus, or device. The computer-readable storage medium has computer instructions stored thereon, which, when executed by a processor, implement the live streaming interaction method according to any of the above embodiments.

The above live streaming interaction method, by creating a new real-time communication sub-channel in the same live streaming room architecture, allows the guest in co-hosting and other users to establish real-time communication, which further meets social needs of the users, thereby improving user experience.

The computer-readable signal medium may include a data signal propagated on a baseband or as a part of a carrier, and computer-readable program code is carried therein. This propagated data signal may take many forms, including but not limited to, an electromagnetic signal, an optical signal, or any suitable combination of the above. The computer-readable signal medium may also be any computer-readable medium other than the computer-readable storage medium, and the computer-readable signal medium may send, propagate, or transmit a program for use by or in connection with an instruction execution system, apparatus, or device. The program code embodied on the computer-readable medium may be transmitted by any suitable medium, including but not limited to: a wire, an optical cable, a radio frequency (RF), etc., or any suitable combination of the above.

The above computer-readable medium may be included in the above electronic device; or it may exist alone without being assembled into the electronic device.

In some embodiments, there is further provided a computer program, including: instructions that, when executed by a processor, cause the processor to perform the method according to any of the above embodiments. For example, the instructions may be embodied as computer program code.

In the embodiments of the present disclosure, the computer program code for performing the operations of the present disclosure may be written in one or more programming languages or a combination thereof, where the programming languages include but not limited to object-oriented programming languages such as Java, Smalltalk, and C++, and include conventional procedural programming languages such as "C" language or similar programming languages. The program code may be executed entirely on a user's computer, partly executed on a user's computer, executed as an independent software package, partly executed on a user's computer and partly executed on a remote computer, or entirely executed on a remote computer or server. In the case involving a remote computer, the remote computer may be connected to a user's computer through any kind of network (including a local area network (LAN) or a wide area network (WAN)), or it may be connected to an external computer (for example, connected by using Internet provided by an Internet service provider).

The flowchart and block diagrams in the drawings illustrate the possibly implemented architectures, functions, and operations of the system, method, and computer program product according to various embodiments of the present disclosure. In this regard, each block in the flowchart or block diagram may represent a module, program segment, or part of code, which includes one or more executable instructions for implementing the specified logical functions. It should also be noted that, in some alternative implementations, the functions marked in the blocks may also occur in an order different from that marked in the drawings. For example, two blocks shown in succession may actually be performed substantially in parallel, or they may sometimes be performed in the reverse order, depending on the functions involved. It should also be noted that each block in the block diagram and/or the flowchart, and a combination of the blocks in the block diagram and/or the flowchart may be implemented by a dedicated hardware-based system that executes specified functions or operations, or may be implemented by a combination of dedicated hardware and computer instructions.

The functions described above may be performed at least in part by one or more hardware logic components. For example, without limitation, exemplary hardware logic components that may be used include: a field programmable gate array (FPGA), an application specific integrated circuit (ASIC), an application specific standard product (ASSP), a system on chip (SOC), a complex programmable logical device (CPLD), etc.

Although some specific embodiments of the present disclosure have been described in detail by way of examples, those skilled in the art should understand that the above examples are only for illustration, rather than limiting the scope of the present disclosure. Those skilled in the art should understand that the above embodiments may be modified without departing from the scope and spirit of the present disclosure. The scope of the present disclosure is defined by the appended claims.

What is claimed is:

1. A live streaming interaction method, applied to a server, comprising:
sending an invitation to a second user, in response to receiving a request for communicating with the second user sent by a first user, wherein at least one of the first user or the second user is a user in a first real-time communication channel of a live streaming;
creating, for the live streaming, a second real-time communication channel for communication between the first user and the second user, wherein the second real-time communication channel is different from the first real-time communication channel; and
sending a configuration corresponding to the second real-time communication channel to the first user and the second user, so that the first user and the second user enter the second real-time communication channel according to the configuration.

2. The live streaming interaction method of claim 1, wherein the configuration comprises:
a first parameter configured to indicate the live streaming, wherein the second real-time communication channel has a same first parameter as the first real-time communication channel; and
a second parameter configured to indicate a category of the real-time communication channel, wherein the second real-time communication channel has a different second parameter from the first real-time communication channel.

3. The live streaming interaction method of claim 2, further comprising:
creating, for the live streaming, a third real-time communication channel for communication between other users, wherein the third real-time communication channel has a same first parameter and a same second parameter as the second real-time communication channel, and a third parameter corresponding to the third real-time communication channel is different from a third parameter corresponding to the second real-time communication channel, the third parameter being comprised in the configuration and configured to indicate a number of the real-time communication channel.

4. The live streaming interaction method of claim 1, further comprising:
distributing a first message related to the first real-time communication channel and a second message related to the second real-time communication channel through different connection channels between a message server and users of the live streaming, respectively.

5. The live streaming interaction method of claim 1, further comprising:
distributing a first message related to the first real-time communication channel and a second message related to the second real-time communication channel through a same connection channel between a message server and users of the live streaming, wherein each of the first message and the second message comprise an identification configured to indicate a message source.

6. The live streaming interaction method of claim 1, further comprising:
determining a connection state of a user in the second real-time communication channel according to connection line user information and actual communication user information of the second real-time communication channel.

7. The live streaming interaction method of claim 1, further comprising:
sending, in response to receiving a stream pulling request sent by a third user of the live streaming, to the third user, stream data of a merged stream of audio and video data of a real-time communication channel corresponding to the stream pulling request, wherein the stream data comprises a stream address of the merged stream.

8. A live streaming interaction method, applied to a user terminal, comprising:
sending, by a first user, an invitation to communicate with a second user, wherein at least one of the first user or the second user is a user in a first real-time communication channel of a live streaming; and
receiving a configuration corresponding to a second real-time communication channel of the live streaming, to enter the second real-time communication channel according to the configuration, wherein the second real-time communication channel is different from the first real-time communication channel, and is configured for communication between the first user and the second user.

9. The live streaming interaction method of claim 8, further comprising:
creating a second real-time communication engine for entering the second real-time communication channel according to a first parameter configured to indicate the live streaming and a second parameter configured to indicate a category of the real-time communication channel in the configuration, the second real-time communication engine being different from a first real-time communication engine streaming to enter the first real-time communication channel.

10. The live streaming interaction method of claim 9, further comprising:
determining a channel instance corresponding to a third parameter in the real-time communication engine according to the third parameter configured to indicate a number of the real-time communication channel in the configuration; and
entering the second real-time communication channel through the channel instance.

11. The live streaming interaction method of claim 8, further comprising:
receiving, from a message server, a first message related to the first real-time communication channel and a second message related to the second real-time communication channel through a same connection channel, wherein each of the first message and the second message comprise an identification configured to indicate a message source; and
displaying a corresponding message according to the identification.

12. The live streaming interaction method of claim 8, further comprising:
sending, by a third user, a stream pulling request;
receiving stream data of a merged stream of audio and video data of a real-time communication channel corresponding to the stream pulling request, wherein the stream data comprises a stream address of the merged stream; and
acquiring the merged stream according to the stream address.

13. The live streaming interaction method of claim 12, wherein acquiring the merged stream according to the stream address comprises:
acquiring the merged stream according to the stream address in a first stream pulling manner, in response to an identification in the stream data, which is configured to indicate a source of the merged stream, indicating that the source of the merged stream is the first real-time communication channel; or
acquiring the merged stream according to the stream address in a second stream pulling manner, in response to the identification indicating that the source of the merged stream is the second real-time communication channel, wherein the second stream pulling manner has a lower stream pulling latency than the first stream pulling manner.

14. The live streaming interaction method of claim 12, further comprising:
stopping audio publishing in the first real-time communication channel, in response to the third user being a streamer user; or
stopping audio and video publishing in the first real-time communication channel, and stopping subscribing to audio of other users in the first real-time communication channel, in response to the third user being a non-streamer user.

15. An electronic device, comprising:
at least one memory; and
at least one processor coupled to the at least one memory, the at least one processor configured to, based on instructions stored in the at least one memory, carry out a live streaming interaction method, comprising:
sending an invitation to a second user, in response to receiving a request for communicating with the second user sent by a first user, wherein at least one of the first user or the second user is a user in a first real-time communication channel of a live streaming;
creating, for the live streaming, a second real-time communication channel for communication between the first user and the second user, wherein the second real-time communication channel is different from the first real-time communication channel; and
sending a configuration corresponding to the second real-time communication channel to the first user and the second user, so that the first user and the second user enter the second real-time communication channel according to the configuration.

16. The electronic device of claim 15, wherein the configuration comprises:
a first parameter configured to indicate the live streaming, wherein the second real-time communication channel has a same first parameter as the first real-time communication channel; and
a second parameter configured to indicate a category of the real-time communication channel, wherein the second real-time communication channel has a different second parameter from the first real-time communication channel.

17. The electronic device of claim 16, wherein the processor is further configured for:
creating, for the live streaming, a third real-time communication channel for communication between other users, wherein the third real-time communication channel has a same first parameter and a same second parameter as the second real-time communication channel, and a third parameter corresponding to the third real-time communication channel is different from a third parameter corresponding to the second real-time communication channel, the third parameter being comprised in the configuration and configured to indicate a number of the real-time communication channel.

18. An electronic device, comprising:
at least one memory; and
at least one processor coupled to the at least one memory, the at least one processor configured to, based on instructions stored in the at least one memory, carry out the live streaming interaction method of claim 8.

19. A non-transitory computer-readable storage medium, having computer instructions stored thereon, which, when executed by a processor, implements the live streaming interaction method of claim 1.

20. A non-transitory computer-readable storage medium, having computer instructions stored thereon, which, when executed by a processor, implements the live streaming interaction method of claim 8.
